(19) United States
(12) Patent Application Publication
(10) Pub. No.: US 2025/0354458 A1
(43) Pub. Date: Nov. 20, 2025

(54) Stabbing Value Installation tool

(71) Applicant: Brent Dudley, Taylor (CA)

(72) Inventor: Brent Dudley, Taylor (CA)

(21) Appl. No.: 18/667,576

(22) Filed: May 17, 2024

(51) Int. Cl. E21B 34/06

(52) U.S. Cl. CPC E21B 34/06

(57) ABSTRACT

A stabbing valve tool is disclosed herein. The stabbing valve tool includes a frame defining an opening for receiving a stabbing valve, a first handle attached to a left side of the frame and a second handle attached to a right side of the frame. The first handle includes a hex head tool for opening and closing the stabbing valve. The second handle is preferably removable from the frame, for example, via a threaded connection to the frame. The stabbing valve tool provides improved installation and use of the stabbing valve.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of stabbing valves of existing art and more specifically relates to a tool for aiding in installation and use of a stabbing valve.

### RELATED ART

A drilling rig functions as a comprehensive system designed to bore wells into the subsurface of the Earth, whether for oil, water, or construction purposes. These rigs vary widely in size and complexity, ranging from massive structures equipped for oil, gas, or water well drilling to portable units.

In every drilling rig, it is essential to have a valve easily reachable on the rig floor. Commonly referred to as a “stabbing valve,” this valve plays a crucial role in mitigating potential risks, acting as a contingency and swiftly engaging to prevent potential hazards associated with sudden well flow, such as blowouts or uncontrolled releases of fluids or gas. In such an event, rig personnel swiftly install the stabbing valve into the connection on the rig floor and promptly close it to halt flow through the drill string, ensuring operational safety. Thus, stabbing valves offer reliable performance and ease of use in managing fluid flow within the drilling system.

However, current tools and methods for installing the stabbing valve are often arduous and chaotic. Accordingly, a suitable solution is desired.

### SUMMARY OF THE INVENTION

In view of the foregoing disadvantages inherent in the known stabbing valve art, the present disclosure provides a novel stabbing valve installation tool. The general purpose of the present disclosure, which will be described subsequently in greater detail, is to provide an installation tool that combines improved lifting, removable handle(s) and a means of opening and closing the stabbing valve; and enables improved installation and use of the stabbing valve.

A stabbing valve tool is disclosed herein. According to one or more embodiments of the present disclosure, the stabbing valve tool may include a frame defining an opening to accept a stabbing valve, a gripping portion, a first handle and a second handle. The gripping portion may be disposed at an inner surface of a left side of the frame and able to securely grip the stabbing valve within the opening of the frame.

The first handle may be attached to and extending from the left side of the frame and the second handle may be removably attached to and extending from the right side of the frame, opposite the first handle. The first handle may include a hex head tool able to insert into a hex-opening within the stabbing valve to open and close the stabbing valve.

According to one or more other embodiments, a stabbing valve tool may comprise a frame including a first half defining a left side of the frame and a second half defining a right side of the frame and together defining an opening therebetween to accept a stabbing valve. The first half and the second half are able to be moved into a clamping position to secure the stabbing valve within the opening. Accordingly, a first clamp may be attached about a front side of the frame, and a second clamp may be attached to a rear of the frame—the first and second clamp configured to move the first half and the second half into the clamping position. Further, a gripping die may be disposed at an inner surface of the first half of the frame and able to securely grip the stabbing valve in the clamping position.

A first handle may be attached to and extending from the first half and a second handle may be removably attached to and extending from the second half of the frame, opposite the first handle. The first handle may include a hex head tool removable therefrom and able to insert into an opening within the stabbing valve to open and close the stabbing valve. Further, a first lifting eye may be attached about the first clamp and a second lifting eye may be attached about the second clamp. The first lifting eye and the second lifting eye aid in handling of the stabbing valve.

In some embodiments, the first clamp may include a first pair of brackets and a first bolt and nut combination threadably insertable through the first pair of brackets. Similarly, the second clamp may include a second pair of brackets and a second bolt and nut combination threadably insertable into the second pair of brackets.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF FIGURES

The figures which accompany the written portion of this specification illustrate embodiments of the present disclosure, a stabbing valve installation tool, constructed and operative according to the teachings of the present disclosure.

FIG. 1 is a side perspective view of a stabbing valve tool installed on a stabbing valve and including a frame, a pair of clamps, a first handle and a second handle, according to an embodiment of the disclosure.

FIG. 2 is a side perspective view of the first handle including a hex head tool, according to an embodiment of the present disclosure.

FIG. 3A is a side perspective view of the second handle with a telescoping shaft in a downward vertical position, according to an embodiment of the present disclosure.

FIG. 3B is a side perspective view of the telescoping shaft having been moved into a horizontal position in line with a horizontal shaft of the second handle, according to an embodiment of the present disclosure.

FIG. 3C is a side perspective view of the telescoping shaft having been moved into the horizontal shaft, according to an embodiment of the present disclosure.

FIG. 4 is a close-up view of the second handle removed from the frame, according to an embodiment of the present disclosure.

FIG. 5 is a top perspective view of the stabbing valve tool including a gripping portion, according to an embodiment of the present disclosure.

FIG. 6 is a top perspective partially exploded view demonstrating the gripping portion being bolted to the frame, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a stabbing valve installation tool. Generally, the stabbing valve installation tool combines improved lifting, removable handles and valve opening and closing means into one simple tool.

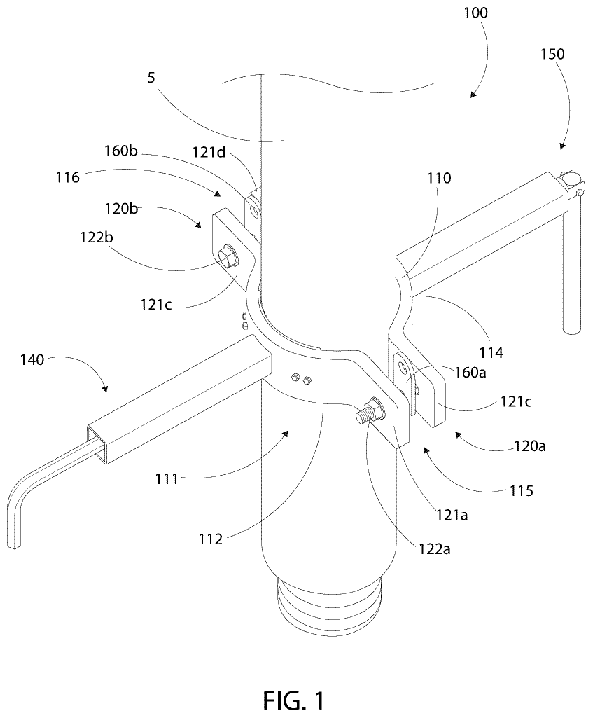

Referring now more specifically to the drawings by numerals of reference, there is shown in FIGS. 1-6, various views of a stabbing valve tool 100. As above, the stabbing valve tool 100 can be used by workers on drilling rigs to install stabbing valves and aids in use of the stabbing valve.

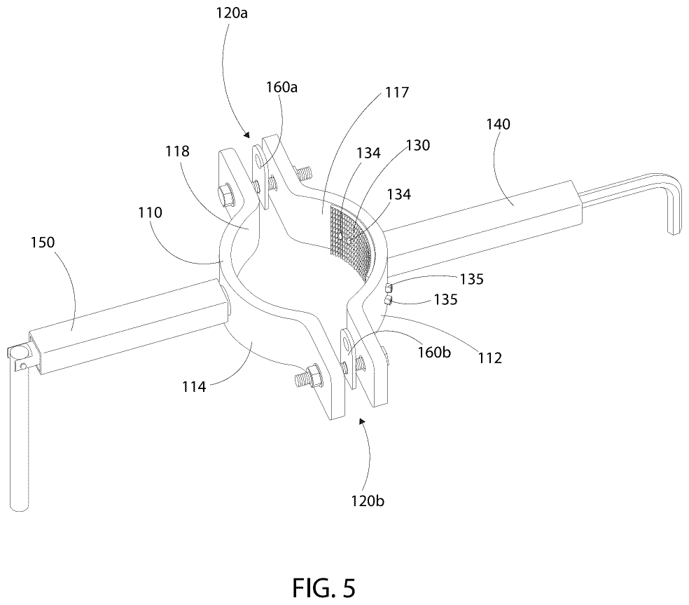

Referring first to FIG. 1, illustrating a perspective view of the stabbing valve tool 100 attached to a stabbing valve 5, according to one or more embodiments of the present disclosure. As shown here, the stabbing valve tool 100 may include a frame 110 defining an opening 113 (FIG. 5) to accept the stabbing valve 5. In some embodiments, the frame 110 may include a first half 112 defining a left side of the frame 110 and a second half 114 defining a right side of the frame 110, together defining the opening 113 to accept the stabbing valve 5.

The first half 112 and the second half 114 are able to be moved into a clamping position 111, as demonstrated here, to secure the stabbing valve 5 within the opening 113. To achieve this, means of moving the first half 112 and the second half 114 into the clamping position 111 are included on the frame 110. For example, as shown here, the stabbing valve tool 100 may further comprise a pair of clamps 120 a, 120 b attached about a front side 115 and a rear side 116 of the frame 110 and configured to move the first half 112 and the second half 114 into the clamping position 111.

In particular, the pair of clamps 120 a, 120 b may include a first clamp 120 a attached about the front side 115 of the frame 110; and a second clamp 120 b attached about the rear side 116 of the frame 110. In some embodiments, as shown here, the pair of clamps 120 a, 120 b may each include a pair of brackets 121 a, 121 b, 121 c, 121 d and a bolt and nut combination 122 a, 122 b threadably insertable through the pair of brackets 121 a, 121 b, 121 c, 121 d. Threading of the bolts 122 a, 122 b move the first half 112 and the second half 114 closer together, thereby bringing the first and second half 114 of the frame 110 into the clamping position 111. As shown here, the pair of brackets 121 a, 121 b, 121 c, 121 d may be integral to the first half 112 and the second half 114 of the frame 110. For example, brackets 121 a and 121 c are integral to the first half 112 and brackets 121 b and 121 d are integral to the second half 114. Bolt 122 a is configured to thread through bracket 121 a and 121 b; and bolt 122 b is configured to thread through bracket 121 c and bracket 121 d.

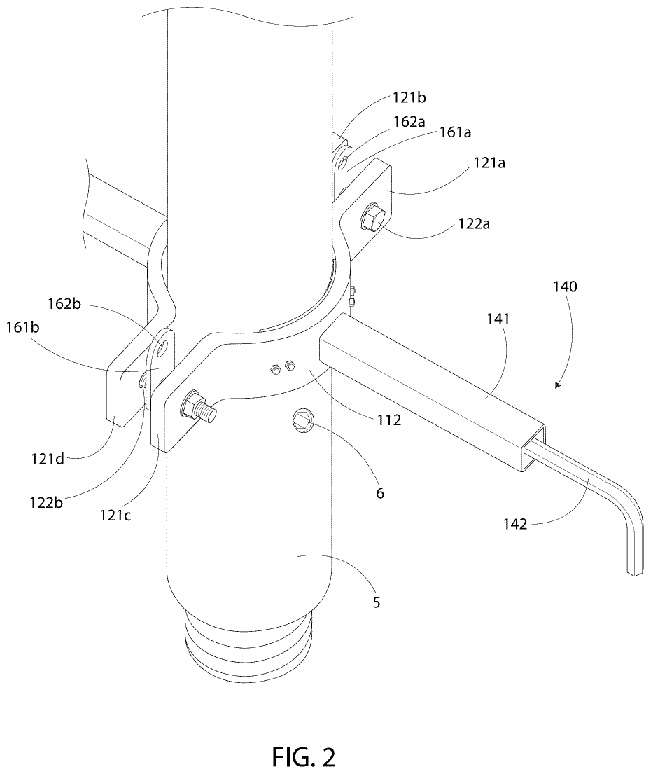

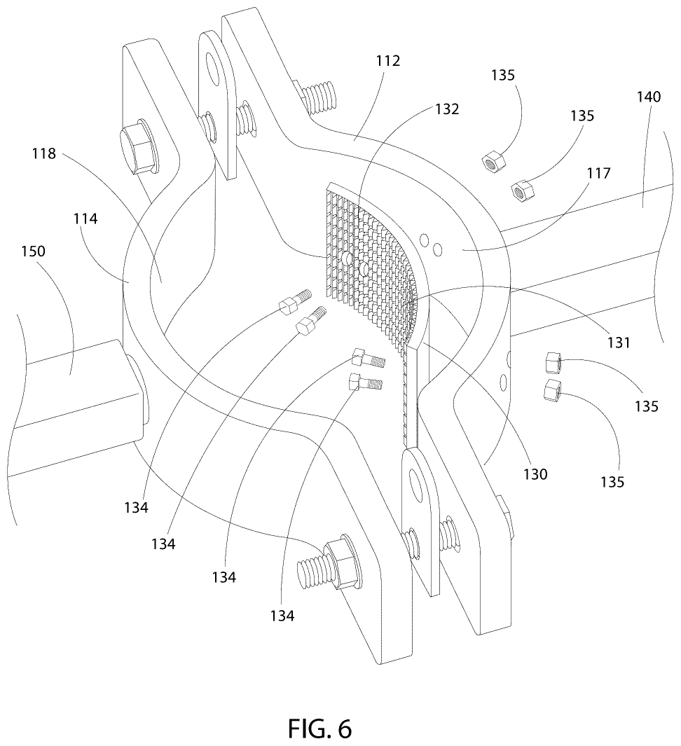

In some embodiments, as shown in FIG. 1 and in FIG. 2, the stabbing valve tool 100 may further comprise a pair of lifting eyes 160 a, 160 b attached about the frame 110. In some embodiments, the lifting eyes 160 a, 160 b may be removable from the stabbing valve tool 100. In some versions, the pair of lifting eyes 160 a, 160 b may include a first lifting eye 160 a attached about the first clamp 120 a, and a second lifting eye 160 b attached about the second clamp 120 b. The lifting eyes 160 a, 160 b may be used to aid in use of the stabbing valve 5 and lifting of the stabbing valve tool 100. As shown in FIG. 6 particularly, the lifting eyes 160 a, 160 b may include an upwardly extending member 161 a, 161 b having an aperture 162 a, 162 b therein.

In some embodiments, the first lifting eye 160 a may be attached in between the pair of brackets 121 a, 121 b of the first clamp 120 a by the bolt from the bolt and nut combination 122 a of the first clamp 120 a. Similarly, the second lifting eye 160 b may be attached in between the pair of brackets 121 c, 121 d of the second clamp 120 b by the bolt from the bolt and nut combination 122 b of the second clamp 120 b.

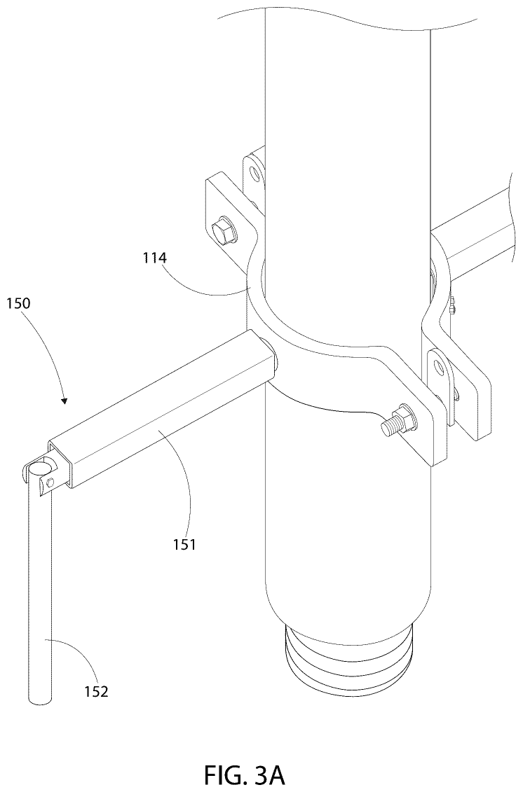

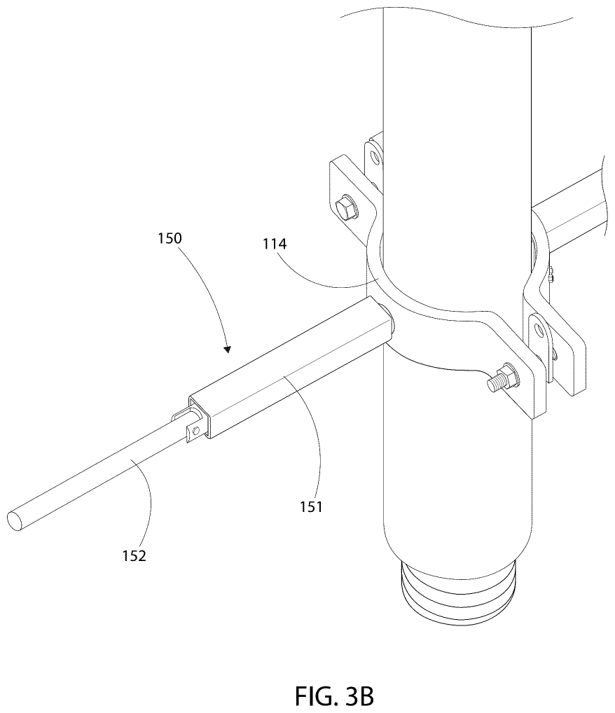

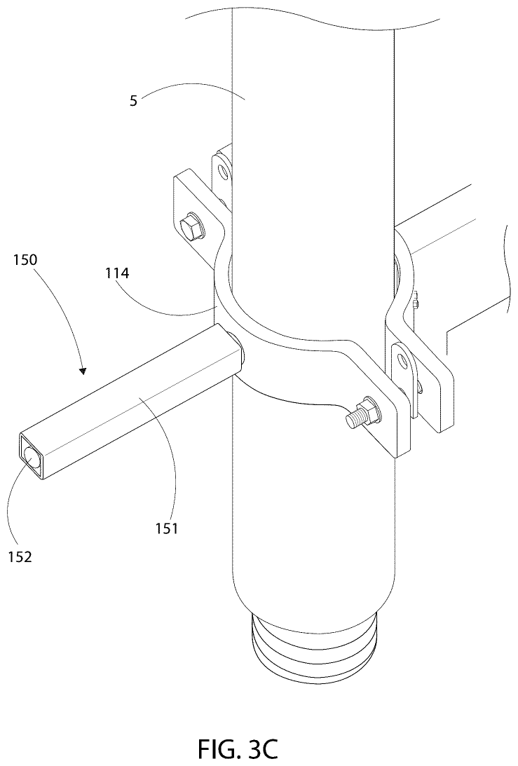

As shown in FIG. 1, the stabbing valve tool 100 further comprises a first handle 140 and a second handle 150, facilitating use of the stabbing valve tool 100 and the stabbing valve 5. In particular, referring now also to FIGS. 2-3B, there are shown various perspective views of the first handle 140 (FIG. 2) and the second handle 150 (FIGS. 3A-3B).

Beginning first with FIG. 2, illustrating the first handle 140, according to one or more embodiments of the present disclosure. As shown here, the first handle 140 may be attached to and extending outwardly from the first half 112 (away from the opening 113 [referenced in FIG. 5]). In particular, the first handle 140 may include a first horizontal shaft 141 extending outwardly from the first half 112, and a hex head tool 142. The first horizontal shaft 141 may be substantially hollow, or at least including interior space, for holding the hex head tool 142. As such, the hex head tool 142 may be removable from the first horizontal shaft 141 and able to be used for insertion into a hex-opening 6 within the stabbing valve 5, as shown in FIG. 2, to open and close the stabbing valve 5. As shown here, the hex head tool 142 may resemble an Allen key-type tool.

Referring now more specifically to FIGS. 3A-3C, illustrating the second handle 150 according to one or more embodiments of the present disclosure. As shown here, the second handle 150 may be attached to and extending outwardly from the second half 114 of the frame 110 (away from the opening 113), opposite the first handle 140. As shown in FIG. 3A, the second handle 150 may include a second horizontal shaft 151 extending outwardly from the second half 114 of the frame 110 and a telescoping shaft 152. The telescoping shaft 152 may be able to be selectively slid in and out of the second horizontal shaft 151, thereby extending the second handle 150.

In some embodiments, as shown in FIGS. 3A-3C, the telescoping shaft 152 may be able to pivot between a downwardly extending vertical position, as shown in FIG. 3A and an outwardly extending horizontal position in line with the second horizontal shaft 151, as shown in FIG. 3B. As shown in FIG. 3C, the telescoping shaft 152 may be slid into the second horizontal shaft 151 when needed, so that the telescoping shaft 152 does not impede installation of the stabbing valve tool 100 and stabbing valve 5.

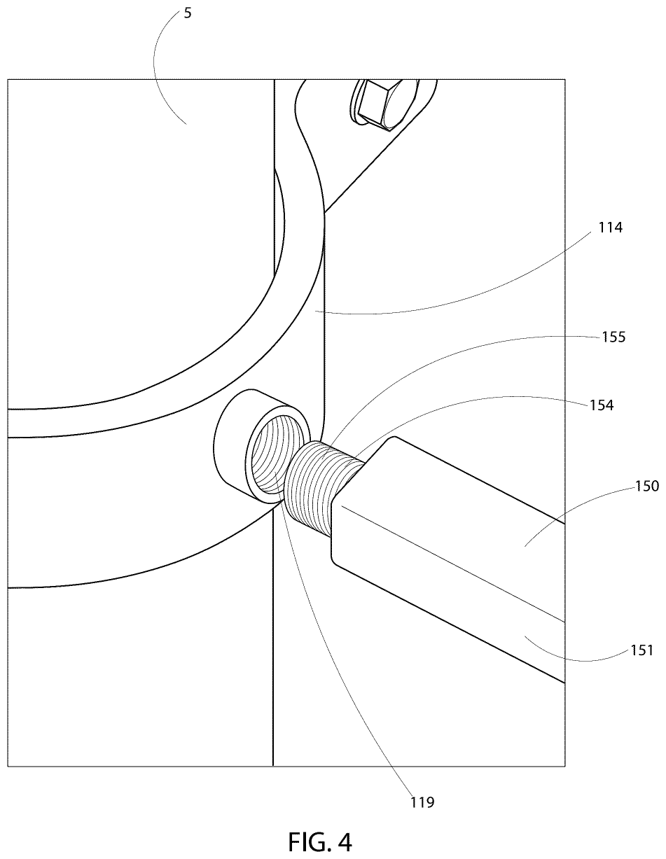

Referring now more specifically to FIG. 4, as shown here, the second handle 150 may be removable from the frame 110 of the stabbing valve tool 100. Particularly, the second handle 150 may be threadably attached to the second half 114 of the frame 110 and able to be selectively removed therefrom. As shown and as above, the second handle 150 may include a second horizontal shaft 151 extending outwardly from the second half 114 of the frame 110.

The second half 114 of the frame 110 may include female threads 119, and the second horizontal shaft 151 may include a threaded member 154 including male threads 155 for connection with the female threads 119 in the second half 114 of the frame 110. The threaded member 154 may be of a sufficient length to contact the stabbing valve 5 in the clamping position 111. Further, this connection may provide durability and stability to the connection between the second handle 150 and the frame 110 such that substantial force is able to be applied to the second handle 150 during use. However, it should be appreciated that the second handle 150 is not limited to being threadably attached to the frame 110.

Referring now more specifically to FIGS. 5-6, there are shown top perspective views of the frame 110 including, as above, the frame 110 including the first half 112 and the second half 114, the pair of clamps 120 a, 120 b, the first handle 140, the second handle 150 and a gripping portion 130. As shown here, the gripping portion 130 may be disposed at an inner surface 117 of the first half 112 of the frame 110 and configured to securely grip the stabbing valve 5 in the clamping position 111 (as demonstrated in FIGS. 1-4).

In some embodiments, the gripping portion 130 may include gripping dies. In particular, the gripping portion 130 may include a plurality of gripping die teeth 132. As shown here, the gripping portion 130 may include a generally concave configuration including the plurality of gripping die teeth 132, disposed at an inner face thereof 131 (facing the opening 113 of the frame 110).

In some embodiments, as shown here, a second gripping portion (not illustrated) may be included at an inner surface 118 of the second half 114. The second gripping portion may include a similar or equal concave configuration; or in other embodiments, the second gripping portion may include a rectangular configuration.

FIG. 6 demonstrates a partially exploded view of the stabbing valve tool 100, illustrating the gripping portion 130 ‘exploded’ from the frame 110. As shown here, the gripping portion 130 may be attached to the frame 110 via bolts 134. The bolts 134 may be recessed into the gripping portion 130 on the inner face 131 thereof, so as to prevent shearing of the bolts 134 during use of the stabbing valve tool 100 on the stabbing valve 5. As shown in FIGS. 5-6, the bolts 134 may thread through from the inner face 131, a head of the bolts 134 are recessed into the inner face 131 of the gripping portion 130 and nuts 135 are threaded onto tails of the bolts 134.

In some embodiments, the stabbing valve tool 100 may further comprise a pair of guides (not illustrated) attached at the right side of the frame 110. For example, in some embodiments, the pair of guides may include a first guide attached to an outer facing edge of the second half 114 toward the front side 115 of the frame 110, and a second guide attached to the outer facing edge of the second half 114 toward the rear side 116 of the frame 110.

It should be noted that, under appropriate circumstances, considering such issues as design preference, user preferences, marketing preferences, cost, structural requirements, available materials, technological advances, etc., other structural elements and methods of use may be taught herein.

It should be understood by one of skill in the art that the disclosed invention is described here in a few exemplary embodiments of many. No particular terminology or description should be considered limiting on the disclosure or the scope of any claims issuing therefrom.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the relevant patent offices and the public generally, and especially the scientist, engineers and practitioners in the art who are not familiar with patent or legal terms or phraseology, to determine quickly from a cursory inspection the nature and essence of the technical disclosure of the application.

1. A stabbing valve tool comprising:
a frame defining an opening to accept a stabbing valve;
a gripping portion disposed at an inner surface of a left side of the frame and able to securely grip the stabbing valve;
a first handle attached to and extending from the left side of the frame, the first handle including a hex head tool able to insert into a hex-opening within the stabbing valve to open and close the stabbing valve; and
a second handle removably attached to and extending from a right side of the frame, opposite the first handle.

2. The stabbing valve tool of claim 1, wherein the frame includes a first half defining the left side of the frame and a second half defining the right side of the frame, the first half and the second half together defining the opening therebetween to accept the stabbing valve.

3. The stabbing valve tool of claim 2, wherein the first half and the second half are able to be moved into a clamping position to secure the stabbing valve within the opening.

4. The stabbing valve tool of claim 3, further comprising a pair of clamps including a first clamp attached about a front side of the frame and a second clamp attached about a rear side of the frame, and wherein the pair of clamps are configured to move the first half and the second half of the frame into the clamping position.

5. The stabbing valve tool of claim 4, wherein the pair of clamps each include a pair of brackets and a bolt and nut combination threadably insertable through the pair of brackets.

6. The stabbing valve tool of claim 5, wherein the pair of brackets are integral to the frame.

7. The stabbing valve tool of claim 1, wherein the second handle is threadably attached to the second half of the frame via a threaded member on the second handle.

8. The stabbing valve tool of claim 7, wherein the threaded member is of a sufficient length to contact the stabbing valve in the clamping position.

9. The stabbing valve tool of claim 8, wherein the second handle is telescopic.

10. The stabbing valve tool of claim 1, wherein the gripping portion includes a generally concave configuration including a plurality of gripping die teeth disposed at an inner face thereof.

11. The stabbing valve tool of claim 10, wherein the gripping portion is attached to the frame via bolts.

12. The stabbing valve tool of claim 11, wherein the bolts are recessed into the inner face of the gripping portion.

13. The stabbing valve tool of claim 1, further comprising a pair of lifting eyes attached about the frame.

14. The stabbing valve tool of claim 13, wherein the pair of lifting eyes includes a first lifting eye attached in between the pair of brackets of the first clamp by the bolt and nut combination of the first clamp, and a second lifting eye attached in between the pair of brackets of the second clamp by the bolt and nut combination of the second clamp.

15. A stabbing valve tool comprising:
a frame including a first half defining a left side of the frame and a second half defining a right side of the frame, the first half and the second half together defining an opening therebetween to accept a stabbing valve, the first half and the second half able to be moved into a clamping position to secure the stabbing valve within the opening;
a first clamp attached about a front side of the frame;
a second clamp attached about a rear side of the frame, and wherein the first clamp and the second clamp are configured to move the first half and the second half into the clamping position;
a gripping die disposed at an inner surface of the first half of the frame and able to securely grip the stabbing valve in the clamping position;
a first handle attached to and extending from the first half, the first handle including a hex head tool removable therefrom and able to insert into a hex-opening within the stabbing valve to open and close the stabbing valve; and
a telescopic second handle removably attached to and extending from the second half of the frame, opposite the first handle;
a first lifting eye attached about the first clamp; and
a second lifting eye attached about the second clamp, and wherein the first lifting eye and the second lifting eye aid in handling of the stabbing valve.

16. The stabbing valve tool of claim 15, wherein the gripping die includes a generally concave configuration including a plurality of gripping die teeth disposed at an inner face thereof.

17. The stabbing valve tool of claim 16, wherein the gripping die is attached to the frame via bolts.

18. The stabbing valve tool of claim 17, wherein the bolts are recessed into the inner face of the gripping die.

19. A stabbing valve tool comprising:
a frame including a first half defining a left side of the frame and a second half defining a right side of the frame, the first half and the second half together defining an opening therebetween to accept a stabbing valve, the first half and the second half able to be moved into a clamping position to secure the stabbing valve within the opening;
a first clamp attached about a front side of the frame, the first clamp including a first pair of brackets and a first bolt and nut combination threadably insertable through the first pair of brackets, wherein threading of the first bolt of the first bolt and nut combination through the first pair of brackets moves the first half and the second half into the clamping position at the front side of the frame;
a second clamp attached about a rear side of the frame, the second clamp including a second pair of brackets and a second bolt and nut combination threadably insertable through the second pair of brackets, wherein threading of the second bolt of the second bolt and nut combination through the second pair of brackets moves the first half and the second half into the clamping position at the rear side of the frame;
a gripping die bolted to the first half of the frame and disposed at an inner surface thereof, the gripping die able to securely grip the stabbing valve in the clamping position;
a first handle attached to and extending from the first half, the first handle including a hex head tool removable therefrom and able to insert into a hex-opening within the stabbing valve to open and close the stabbing valve;
a telescopic second handle removably attached to and extending from the second half of the frame, opposite the first handle;
a first lifting eye attached in between the first pair of brackets of the first clamp by the first bolt of the first bolt and nut combination of the first clamp; and
a second lifting eye attached in between the second pair of brackets of the second clamp by the second bolt of the second bolt and nut combination of the second clamp, and wherein the first lifting eye and the second lifting eye aid in handling of the stabbing valve.

20. The stabbing valve tool of claim 19, wherein the gripping die includes a generally concave configuration including a plurality of gripping die teeth disposed at an inner face thereof.
